(19) United States
(12) Patent Application Publication
(10) Pub. No.: US 2026/0144402 A1
(43) Pub. Date: May 28, 2026

(54) COATING-FREE NON-STICK PANS AND PREPARATION METHODS THEREOF

(71) Applicant: ZHEJIANG JIUKANG ELECTRIC APPLIANCES CO., LTD., Jiaxing (CN)

(72) Inventors: Jiedong XU, Jiaxing (CN); Huaqin WANG, Jiaxing (CN)

(73) Assignee: ZHEJIANG JIUKANG ELECTRIC APPLIANCES CO., LTD., Jiaxing (CN)

(21) Appl. No.: 19/402,915

(22) Filed: Nov. 26, 2025

(30) Foreign Application Priority Data
Nov. 26, 2024 (CN) 202411701290.2

(51) Int. Cl. A47J 36/02; B21B 1/22; C23C 24/06

(52) U.S. Cl. CPC A47J 36/025; B21B 1/22; C23C 24/06

(57) ABSTRACT

Embodiments of the present disclosure provide a coating-free non-stick pan and a preparation method thereof. An inner surface of the non-stick pan is provided with a uniformly distributed micro-nano concave-convex structure. The micro-nano concave-convex structure includes micron-sized concavities and convexities. The micron-sized concavities and convexities include micron-sized protrusions or micron-sized depressions. The micron-sized protrusions are formed by particulate films formed by particles, the particulate films have a thickness of 0.1-0.98 μm, and the particles have a particle size of 0.02-0.3 μm. The micron-sized depressions have a diameter of 0.1-0.98 μm.

### CROSS-REFERENCE TO RELATED APPLICATIONS

This application claims priority to the Chinese Patent Application No. 202411701290.2, filed on Nov. 26, 2024, the contents of which are hereby incorporated by reference.

### TECHNICAL FIELD

The present disclosure generally relates to the field of cooking utensils, and in particular, to a coating-free non-stick pan and a preparation method thereof.

### BACKGROUND

A non-stick pan is a commonly used cooking utensil. An inner surface of the non-stick pan is typically coated with a non-stick layer to reduce the adhesion between the food and the pan, allowing the food to move freely during cooking, thereby making stirring and flipping easier and facilitating cleaning.

In coated non-stick pans, the spatula repeatedly rubs against the pan surface during each cooking session. Prolonged friction can wear down the non-stick layer, preventing the pan from maintaining long-lasting non-stick performance. Additionally, due to the relatively weak adhesion between the coating and the pan body, the coating is prone to detachment during use, posing a risk of contamination of the food with coating material.

Existing non-stick pans, such as non-stick pans with a honeycomb surface structure, have relatively large honeycomb cell sizes, typically greater than 3 millimeters. Although top surfaces of the honeycomb structure are uncoated, the bottoms of the honeycomb cells are still coated, and the coated area generally covers a large portion of the substrate surface, approximately 80-90%. As a result, the contact area between the coating and the food remains large, increasing friction with the food and making it harder to maneuver the spatula.

Therefore, it is necessary to provide a coating-free non-stick pan and a preparation method thereof to ensure that the non-stick performance is maintained during prolonged use.

### SUMMARY

To solve the above problems, the present application provides a coating-free non-stick pan and a preparation method thereof, to prepare a non-stick pan at low cost.

One or more embodiments of the present disclosure provide a coating-free non-stick pan. An inner surface of the non-stick pan is provided with a uniformly distributed micro-nano concave-convex structure. The micro-nano concave-convex structure includes micron-sized concavities and convexities. The micron-sized concavities and convexities include micron-sized protrusions or micron-sized depressions. The micron-sized protrusions are formed by particulate films formed by particles, the particulate films have a thickness of 0.1-0.98 μm, and the particles have a particle size of 0.02-0.3 μm. The micron-sized depressions have a diameter of 0.1-0.98 μm.

### BRIEF DESCRIPTION OF THE DRAWINGS

The present disclosure will be further described by way of exemplary embodiments. These exemplary embodiments will be described in detail with reference to the accompanying drawings. These embodiments are not limiting. In these embodiments, the same reference numerals denote the same structures, where:

FIG. 1 is a schematic diagram illustrating a depressions distribution on an inner surface of a non-stick pan according to some embodiments of the present disclosure; and

FIG. 2 is a schematic diagram illustrating an enlarged view of concave holes on an inner surface of a non-stick pan according to some embodiments of the present disclosure.

### DETAILED DESCRIPTION

Embodiments of the present application are described in detail below. Examples of the embodiments are illustrated in the accompanying drawings. The same or similar reference numerals denote the same objects throughout.

In some embodiments, the present disclosure provides a coating-free non-stick pan. An inner surface of the non-stick pan is provided with a uniformly distributed micro-nano concave-convex structure. The micro-nano concave-convex structure includes micron-sized concavities and convexities. The micron-sized concavities and convexities include micron-sized protrusions or micron-sized depressions. The micron-sized protrusions are formed by particulate films formed by particles, the particulate films have a thickness of 0.1-0.98 μm, and the particles have a particle size of 0.02-0.3 μm. The micron-sized depressions have a diameter of 0.1-0.98 μm.

The micro-nano concave-convex structure refers to a microscopic structure of the inner surface of the non-stick pan. The micro-nano concave-convex structure may include the micron-sized concavities and convexities. The micro-nano concave-convex structure further includes nano-sized concavities and convexities. More descriptions of the nano-sized concavities and convexities may be found in the related description below.

In some embodiments, the micron-sized concavities and convexities include the micron-sized protrusions or the micron-sized depressions. The micron-sized protrusion refers to a micron-sized protruding portion, while the micron-sized depression refers to a micron-sized depressed portion.

In some embodiments, the micron-sized protrusions are formed by particulate films formed by the particles on the inner surface of the non-stick pan. The micron-sized protrusion formed by the particulate film may be obtained by plating micron-sized particles onto the inner surface of the non-stick pan in a plurality of ways.

For example, the particulate film is formed by multi-arc ion plating (MAIP) or similar processes. In a vacuum chamber, a high current (e.g., 60-150 A) is applied to the arc target, an arc is initiated using an arc ignition pin, the arc is generated on the surface of the target. The arc produces localized high temperatures on the target surface (e.g., 8,000-40000K), causing the target material to melt and become plasma, forming micrometer-sized molten particles. By applying a bias voltage to the non-stick pan (e.g., 200-1000V), the molten particles are accelerated under the influence of the electric field and migrate directionally toward the pan. The high-energy particles impact the inner surface of the pan and deposit, thereby forming the particulate film.

As another example, the particulate film is formed by magnetron sputtering. Argon gas is introduced into the vacuum chamber (e.g., 0.1-5 Pa), and a negative bias voltage (e.g., 300-800 V) is applied to the magnetron sputtering target. Argon ions, under the influence of the electric field, bombard the target surface, causing atoms of the target material to be sputtered. The sputtered atoms aggregate into micrometer-sized particles in the argon atmosphere. During migration toward the non-stick pan, some of the particles are ionized, and under the influence of the bias voltage applied to the substrate, they are accelerated and deposited on the inner surface of the pan, forming a particulate film with a thickness of approximately 0.1-0.98 μm.

In some embodiments, a thickness of the particulate film and the particle size of the particles may be adjusted by adjusting conditions such as a target material, a current magnitude, a temperature, and an atmosphere.

In some embodiments, a material of the target material includes, but is not limited to, metal, alloy, nitride, or the like. Merely by way of example, the metal includes chromium, nickel, titanium, and zirconium. Merely by way of example, the nitride includes chromium nitride, and titanium nitride.

In some embodiments, the thickness of the particulate film and the particle size of the particles are determined based on actual needs.

In some embodiments, the particulate film has a thickness of 0.1-0.98 μm, and the particles have a particle size of 0.02-0.3 μm.

In some embodiments, the thickness of the particulate film may also be one of 0.1 μm, 0.2 μm, 0.3 μm, 0.5 μm, 0.7 μm, 0.9 μm, or 0.98 μm.

In some embodiments, the thickness of the particulate film may also be one of 0.1-0.3 μm, 0.2-0.5 μm, 0.3-0.7 μm, 0.5-0.9 μm, 0.7-0.98 μm, 0.1-0.5 μm, 0.3 -0.9 μm, or 0.5-0.98 μm.

In some embodiments, the particle size of the particles may also be one of 0.02 μm, 0.05 μm, 0.1 μm, 0.15 μm, 0.2 μm, 0.25 μm, or 0.3 μm.

In some embodiments, the particle size of the particles may also be one of 0.02-0.1 μm, 0.05-0.2 μm, 0.1-0.3 μm, 0.02-0.15 μm, 0.05-0.25 μm, 0.15-0.3 μm, 0.02-0.2 μm, or 0.1-0.25 μm.

In some embodiments, the micron-sized depressions may be prepared using a pressing process or an etching process. More descriptions about the preparation of the micron-sized depressions may be found in the related description below.

In some embodiments, the micron-sized depressions have a diameter of 0.1-0.98 μm.

In some embodiments, the diameter of the micron-sized depressions may also be one of 0.1 μm, 0.2 μm, 0.3 μm, 0.5 μm, 0.7 μm, 0.9 μm, or 0.98 μm.

In some embodiments, the diameter of the micron-sized depressions may also be one of 0.1-0.3 μm, 0.2-0.5 μm, 0.3-0.7 μm, 0.5-0.9 μm, 0.7-0.98 μm, 0.1-0.5 μm, 0.3-0.9 μm, or 0.5-0.98 μm.

In some embodiments, the micron-sized depressions are provided with multi-level diameter dimensions. A diameter distribution of the micron-sized depressions further includes 40±20 μm or 5±2 μm. The micron-sized depressions may be prepared using the pressing process or the etching process. The micron-sized depressions have a depth of 20-1500 nm.

In some embodiments, the micron-sized depressions provided with the multi-level diameter dimensions indicate that a plurality of micron-sized depressions with different diameter distributions are distributed on the inner surface of the non-stick pan.

In some embodiments, the diameter distribution of the micron-sized depressions further includes 40±20 μm or 5±2 μm.

The notation 40±20 μm indicates that the diameter distribution of the micron-sized depressions is in a range of 20-60 μm.

In some embodiments, the diameter of the micron-sized depressions of 40±20 μm may also be one of 20 μm, 30 μm, 40 μm, 50 μm, or 60 μm.

In some embodiments, the diameter of the micron-sized depressions of 40±20 μm may also be one of 20-30 μm, 30-40 μm, 40-50 μm, 50-60 μm, 20-40 μm, 30-50 μm, or 40-60 μm.

The notation 5±2 μm indicates that the diameter distribution of the micron-sized depressions is in a range of 3-7 μm.

In some embodiments, the diameter of the micron-sized depressions of 5±2 μm may also be one of 3 μm, 4 μm, 5 μm, 6 μm, 7 μm, 3.5 μm, or 6.5 μm.

In some embodiments, the diameter of the micron-sized depressions of 5±2 μm may also be one of 3-4 μm, 4-5 μm, 5-6 μm, 6-7 μm, 3-5 μm, 4-6 μm, 5-7 μm, 3-6 μm, or 4-7 μm.

In some embodiments, a diameter distribution of the micron-sized depressions includes 40±20 μm, 5±2 μm, and 0.2±0.1 μm, which indicates that the inner surface of the non-stick pan includes three types of micron-sized depressions with different diameter distributions.

The notation 0.2±0.1 μm indicates that the diameter distribution of the micron-sized depressions is in a range of 0.1-0.3 μm.

In some embodiments, the diameter of the micron-sized depressions of 0.2±0.1 μm may also be one of 0.1 μm, 0.15 μm, 0.2 μm, 0.25 μm, or 0.3 μm.

In some embodiments, the diameter of the micron-sized depressions of 0.2±0.1 μm may also be one of 0.1-0.15 μm, 0.15-0.2 μm, 0.2-0.25 μm, 0.25-0.3 μm, 0.1-0.2 μm, 0.15-0.25 μm, 0.2-0.3 μm, 0.1-0.25 μm, or 0.15-0.3 μm.

In some embodiments, the micron-sized depressions have a depth of 20-1500 nm.

In some embodiments, the depth of the micron-sized depressions may also be one of 20 nm, 100 nm, 200 nm, 300 nm, 500 nm, 800 nm, 1000 nm, 1200 nm, 1400 nm, or 1500 nm.

In some embodiments, the depth of the micron-sized depressions may also be one of 20-100 nm, 100-200 nm, 200-300 nm, 300-500 nm, 500-800 nm, 800-1000 nm, 1000-1200 nm, 1200-1400 nm, 1400-1500 nm, 20-200 nm, 100-300 nm, 200-500 nm, 300-800 nm, 500-1000 nm, 800-1200 nm, 1000-1400 nm, 1200-1500 nm, 20-500 nm, 100-800 nm, 200-1000 nm, 300-1200 nm, 500-1400 nm, or 800-1500 nm.

In some embodiments, by configuring the diameter distribution of the micron-sized depressions to include 40±20 μm, 5±2 μm, and 0.2±0.1 μm, multi-scale micron-sized depressions including large, medium, and small depressions may be obtained, thus forming a multi-scale non-stick layer. Such a layer further reduces friction between food and the inner surface of the coating-free non-stick pan, and achieves a non-stick effect through physical means without increasing the amount of chemical coating, thereby enabling consumers to cook food more healthily.

In some embodiments, the micron-sized depressions are prepared using the pressing process or the etching process.

The pressing process causes physical deformation of the inner surface of the non-stick pan through mechanical pressure, thereby obtaining the micron-sized depressions. Merely by way of example, a roller having micron-sized protrusions on its surface may be used to press the micron-sized depressions onto the inner surface of the non-stick pan.

In some embodiments, the pressing process further includes a roll pressing or a flat pressing. More descriptions about the pressing process may be found in the related description below.

The etching process chemically etches the inner surface of the non-stick pan to form the micron-sized depressions. For example, micron-scale photoresist patterns may be printed on the inner surface of the non-stick pan by screen printing, and then the exposed surface is chemically etched using an etchant (e.g., hydrochloric acid), while the surface covered by the photoresist remains unaffected. After cleaning to remove the photoresist and residual etchant, the micron-sized depressions are obtained. By adjusting the fineness and pattern of the screen, different types of micron-sized depressions can be obtained.

In some embodiments, the diameter distribution of the micron-sized depressions further includes 40±20 μm or 5±2 μm. The micron-sized depressions are prepared using the pressing process or the etching process, where the pressing process is suitable for soft metals and the etching process is suitable for hard metals such as stainless steel and titanium, thereby expanding the range of materials for preparing the non-stick pan. The micron-sized depressions having a depth of 20-1500 nm ensure a significant reduction in contact area between the food and the inner surface of the non-stick pan while preventing food residue retention caused by excessive depth.

In some embodiments, a material of the inner surface is determined based on actual needs. For example, the material of the inner surface includes stainless steel, titanium, or iron.

In some embodiments, the material of the inner surface includes stainless steel, titanium, or iron. These metals possess chemically stable properties, comply with food contact material safety standards, exhibit excellent corrosion resistance, and offer a long service life.

In some embodiments, when the material of the inner surface is stainless steel or titanium, a material of an outer surface or an intermediate layer of the non-stick pan includes aluminum.

In some embodiments, when the material of the inner surface is stainless steel or titanium, the poor thermal conductivity of stainless steel and titanium can easily lead to localized overheating of the non-stick pan. Therefore, using highly thermally conductive aluminum as the intermediate layer or the outer surface is conducive to improving the thermal uniformity of the non-stick pan.

In some embodiments, the inner surface of the non-stick pan is provided with uniformly distributed concave holes. The concave holes have a pore diameter of 0.1-0.8 mm, an inter-edge distance of 0.1-2 mm, and a hole depth of 0.01-0.3 mm, and a projection area of the concave holes constitutes 15-40% of a pan body area. The concave holes are in a circular or polygonal shape.

The concave hole refers to a micropore on the inner surface of the non-stick pan. The concave holes can form microscopic oil-retaining spaces on the inner surface of the non-stick pan. During cooking, the oil can uniformly fill the concave holes to form a continuous oil film, which prevents food from sticking to the pan. Besides, the concave holes can also reduce the contact area between the food and the inner surface of the non-stick pan, thereby alleviating the sticking effect. The concave holes may be concave holes of a single type or concave holes of a plurality of types.

In some embodiments, the concave holes are uniformly distributed on the inner surface of the non-stick pan. That is, a density of the concave holes in a bottom region of the non-stick pan is equal to a density of the concave holes in a peripheral region of the non-stick pan. The peripheral region may include a sidewall region and a rim region of the non-stick pan.

In some embodiments, the inner surface of the non-stick pan is provided with non-uniformly distributed concave holes. That is, the density of the concave holes in the bottom region is greater than the density of the concave holes in the peripheral region.

In some embodiments, by configuring the density of the concave holes in the bottom region to be greater than the density of the concave holes in the peripheral region, since the bottom region is in direct contact with food and serves as the core heating area during cooking, the risk of food sticking in the bottom region is higher than that in the peripheral region. By increasing the density of the concave holes in the bottom region, denser oil-retaining spaces can be formed in the bottom region and the contact area between the food and the inner surface of the non-stick pan can be reduced, thus preventing food from sticking.

In some embodiments, the concave holes have a pore diameter of 0.1-0.8 mm.

In some embodiments, the pore diameter of the concave holes may also be one of 0.1 mm, 0.3 mm, 0.5 mm, or 0.8 mm.

In some embodiments, the pore diameter of the concave holes may also be one of 0.1-0.3 mm, 0.5-0.8 mm, 0.1-0.5 mm, or 0.3-0.8 mm.

In some embodiments, the concave holes have a pore diameter of 0.3-0.5 mm.

In some embodiments, the pore diameter of the concave holes may also be one of 0.3 mm, 0.35 mm, 0.4 mm, 0.45 mm, or 0.5 mm.

In some embodiments, the pore diameter of the concave holes may also be one of 0.3-0.4 mm, 0.35-0.45 mm, 0.4-0.5 mm, 0.3-0.45 mm, or 0.35-0.5 mm.

The inter-edge distance refers to an average distance between the center points of two adjacent concave holes. In some embodiments, the concave holes have an inter-edge distance of 0.1-2 mm.

In some embodiments, the inter-edge distance may also be one of 0.1 mm, 0.5 mm, 1 mm, or 2 mm.

In some embodiments, the inter-edge distance may also be one of 0.1-0.5 mm, 0.5-1 mm, 1-2 mm, 0.1-1 mm, or 0.5-2 mm.

In some embodiments, the concave holes have a hole depth of 0.01-0.3 mm. In some embodiments, the hole depth may also be one of 0.01 mm, 0.1 mm, 0.2 mm, or 0.3 mm.

In some embodiments, the hole depth may also be one of 0.01-0.1 mm, 0.1-0.2 mm, 0.2-0.3 mm, 0.01-0.2 mm, or 0.1-0.3 mm.

The projection area of the concave holes refers to a total two-dimensional area of all the concave holes projected onto the inner surface of the non-stick pan. An appropriate projection area can reduce the contact area between the food and the inner surface, thereby reducing the likelihood of food sticking. In some embodiments, the projection area of the concave holes constitutes 15-40% of the pan body area.

In some embodiments, the projection area of the concave holes constitutes one of 15%, 20%, 25%, 30%, 35%, or 40% of the pan body area.

In some embodiments, the projection area of the concave holes constitutes one of 15-25%, 20-30%, 25-35%, 30-40%, 15-30%, 20-35%, or 25-40% of the pan body area.

In some embodiments, by further providing the uniformly distributed concave holes on the inner surface of the non-stick pan, where the concave holes have the pore diameter of 0.1-0.8 mm, the inter-edge distance of 0.1-2 mm, and the hole depth of 0.01-0.3 mm, the projection area of the concave holes constitutes 15-40% of the pan body area, and the concave holes are in a circular or polygonal shape, it is ensured that a suitable number of uniformly distributed concave holes are distributed on the inner surface of the non-stick pan. Such a configuration ensures the non-stick performance of the non-stick pan while preventing an excessive number of concave holes from compromising the structural strength, thereby maintaining the service life.

In some embodiments, the shape of the concave holes may be determined based on actual needs. For example, the concave holes are in an oval or irregular shape.

In some embodiments, the concave holes are in a circular or polygonal shape. The polygon shape may include a triangle, a hexagon, or the like.

The specific shape of the concave holes may be determined based on actual needs. For example, the concave holes have a steep, inward-curved shape, with the sidewalls of the concave holes nearly perpendicular to the inner surface of the non-stick pan, and sharp edges at the boundaries of the concave holes.

In some embodiments, the concave holes have a continuously concave profile. The continuously concave profile refers to the concave hole formed by a gradual downward curvature of the inner surface of the non-stick pan, with no sharp edges at the boundaries of the concave hole.

In some embodiments, a process for preparing the concave holes includes pressing the non-stick pan using a press machine with protrusions on an alloy mold to form the concave holes. The alloy mold may match the size and shape of a pan body and the non-stick pan. When the protrusion is circular, circular concave holes may be formed; when the protrusion is polygonal, polygonal concave holes may be formed.

In some embodiments, the concave holes include a first-type concave hole and a second-type concave hole. The first-type concave hole has a pore diameter of 0.3-0.8 mm, an inter-edge distance of 0.6-8 mm, and a hole depth of 0.01-0.3 mm. The second-type concave hole has a pore diameter of 0.05-0.29 mm, an inter-edge distance of 0.1-0.9 mm, and a hole depth of 0.01-0.3 mm.

In some embodiments, the pore diameter of the first-type concave hole may be one of 0.3 mm, 0.4 mm, 0.5 mm, 0.6 mm, 0.7 mm, or 0.8 mm. The inter-edge distance of the first-type concave hole may be one of 0.6 mm, 1.5 mm, 3 mm, 5 mm, 6.5 mm, or 8 mm. The hole depth of the first-type concave hole may be one of 0.01 mm, 0.05 mm, 0.1 mm, 0.15 mm, 0.2 mm, 0.25 mm, or 0.3 mm.

In some embodiments, the pore diameter of the first-type concave hole may be one of 0.3-0.5 mm, 0.4-0.6 mm, 0.5-0.7 mm, 0.6-0.8 mm, 0.3-0.6 mm, 0.4-0.7 mm, or 0.5-0.8 mm. The inter-edge distance of the first-type concave hole may be one of 0.6-3 mm, 1.5-5 mm, 3-6.5 mm, 5-8 mm, 0.6-5 mm, 1.5-6.5 mm, or 3-8 mm. The hole depth of the first-type concave hole may be one of 0.01-0.1 mm, 0.05-0.2 mm, 0.1-0.3 mm, 0.01-0.15 mm, 0.05-0.25 mm, or 0.15-0.3 mm.

In some embodiments, the pore diameter of the second-type concave hole may be one of 0.05 mm, 0.1 mm, 0.15 mm, 0.2 mm, 0.25 mm, or 0.29 mm. The inter-edge distance of the second-type concave hole may be one of 0.1 mm, 0.2 mm, 0.3 mm, 0.5 mm, 0.7 mm, or 0.9 mm. The hole depth of the second-type concave hole may be one of 0.01 mm, 0.05 mm, 0.1 mm, 0.15 mm, 0.2 mm, 0.25 mm, or 0.3 mm.

In some embodiments, the pore diameter of the second-type concave hole may be one of 0.05-0.15 mm, 0.1-0.2 mm, 0.15-0.25 mm, 0.2-0.29 mm, 0.05-0.2 mm, 0.1-0.25 mm, or 0.15-0.29 mm. The inter-edge distance of the second-type concave hole may be one of 0.1-0.3 mm, 0.2-0.5 mm, 0.3-0.7 mm, 0.5-0.9 mm, 0.1-0.5 mm, 0.2-0.7 mm, or 0.3-0.9 mm. The hole depth of the second-type concave hole may be one of 0.01-0.1 mm, 0.05-0.2 mm, 0.1-0.3 mm, 0.01-0.15 mm, 0.05-0.25 mm, or 0.15-0.3 mm.

In some embodiments, the concave holes include the first-type concave hole and the second-type concave hole, where the first-type concave hole has a pore diameter of 0.3-0.8 mm, an inter-edge distance of 0.6-8 mm, and a hole depth of 0.01-0.3 mm; and the second-type concave hole has a pore diameter of 0.05-0.29 mm, an inter-edge distance of 0.1-0.9 mm, and a hole depth of 0.01-0.3 mm. A combination of large concave holes and small concave holes forms multi-scale oil-retaining spaces, thus further improving the non-stick performance.

In some embodiments, the present disclosure provides a process for preparing a coating-free non-stick pan, comprising:

Operation 1, preparing a mixed slurry by proportionally mixing hard fine grains and coating the mixed slurry onto a surface of a metal plate to obtain a coated metal plate.

The hard fine grains refer to fine particles with high hardness. Under pressure, the hard fine grains cause plastic deformation of the surface of the metal plate, ultimately forming depressions matching the sizes of the hard fine grains. By using hard fine grains with different particle sizes, depressions with a single pore diameter or depressions with a plurality of pore diameters are obtained.

In some embodiments, a particle size distribution and a material of the hard fine grains are determined based on actual needs. For example, the hard fine grains include hard metals such as tungsten powder, molybdenum powder, chromium powder, and titanium powder. As another example, the hard fine grains include metal compounds or alloys such as tungsten carbide, titanium carbide, titanium boride, nickel-based alloys, and cobalt-based alloys.

In some embodiments, the hard fine grains include cerium salts containing tetravalent cerium ions and oxidants. The cerium salts containing tetravalent cerium ions exhibit strong oxidizing properties. When used in combination with the oxidants, they can induce oxidation reactions on the surface of the metal plate, etching the metal surface and forming nano-sized depressions.

In some embodiments, a volume proportion of the hard fine grains in the mixed slurry is determined based on actual needs.

In some embodiments, the volume proportion of the hard fine grains in the mixed slurry is 8%-30%.

In some embodiments, the volume proportion of the hard fine grains in the mixed slurry may be one of 8%, 10%, 12%, 15%, 18%, 20%, 22%, 25%, 28%, or 30%.

In some embodiments, the volume proportion of the hard fine grains in the mixed slurry may be one of 8-15%, 10-20%, 15-25%, 20-30%, 8-20%, 12-28%, 8-25%, or 15-30%.

In some embodiments, the particle size distribution of the hard fine grains includes at least two particle sizes of 50±20 μm, 5±2 μm, and 0.2±0.1 μm.

In some embodiments, the notation 50±20 μm may be one of 30 μm, 40 μm, 50 μm, 60 μm, or 70 μm. The notation 5±2 μm may be one of 3 μm, 4 μm, 5 μm, 6 μm, or 7 μm. The notation 0.2±0.1 μm may be one of 0.1 μm, 0.2 μm, or 0.3 μm.

In some embodiments, the notation 50±20 μm may be one of 30-40 μm, 40-50 μm, 50-60 μm, 60-70 μm, 30-50 μm, 40-60 μm, or 50-70 μm. The notation 5±2 μm may be one of 3-4 μm, 4-5 μm, 5-6 μm, 6-7 μm, 3-5 μm, 4-6 μm, or 5-7 μm. The notation 0.2±0.1 μm may be one of 0.1-0.2 μm, 0.2-0.3 μm, or 0.1-0.3 μm.

In some embodiments, the hard fine grains have a particle size of 0.2±0.1 μm, and the particle size distribution of the hard fine grains includes at least one particle size of 50±20 μm and 5±2 μm.

In some embodiments, by blending hard fine grains of different sizes, for example, the particle size distribution of hard fine grains includes at least two particle sizes of 50±20 μm and 5±2 μm, and 0.2±0.1 μm; or the particle size distribution of the hard fine grains includes at least one particle size of 0.2±0.1 μm, 50±20 μm and 5±2 μm. Such a configuration can form multi-scale depressions on the surface of the metal plate to form oil-retaining spaces of different sizes, thus further improving the non-stick performance.

In some embodiments, the micro-nano concave-convex structure further includes nano-sized concavities and convexities. Surfaces of the micron-sized concavities and convexities are superimposed with the nano-sized concavities and convexities. The micron-sized concavities and convexities have a diameter distribution of 0.2-100 μm, and the nano-sized concavities and convexities have a diameter distribution of 0.01-0.2 μm.

The nano-sized concavities and convexities refer to a concave-convex structure with smaller sizes. The nano-sized concavities and convexities include nano-sized protrusions and nano-sized depressions. The surfaces of the micron-sized concavities and convexities are superimposed with the nano-sized concavities and convexities.

In some embodiments, a diameter distribution of the micron-sized concavities and convexities may be one of 0.2 μm, 1 μm, 5 μm, 10 μm, 20 μm, 50 μm, or 100 μm. The diameter distribution of the nano-sized concavities and convexities may be one of 0.01 μm, 0.05 μm, 0.1 μm, 0.15 μm, or 0.2 μm.

In some embodiments, the diameter distribution of the micron-sized concavities and convexities may be one of 0.2-1μm, 1-10 μm, 10-20 μm, 20-50 μm, 50-100 μm, 0.2-10 μm, 10-50 μm, 0.2-50 μm, or 1-100 μm.

In some embodiments, the diameter distribution of the nano-sized concavities and convexities may be one of 0.01-0.05 μm, 0.05-0.1 μm, 0.1-0.15 μm, 0.15-0.2 μm, 0.01-0.1 μm, 0.05-0.2 μm, or 0.01-0.2 μm.

In some embodiments, operations for preparing the nano-sized protrusions are similar to operations for preparing micron-sized protrusions. After forming particulate films by means such as multi-arc ion plating, nano-sized molten particle droplets with a size of 0.01-0.2 μm are deposited onto the inner surface of the non-stick pan by adjusting parameters such as current, temperature, and atmospheric conditions, thereby forming the nano-sized protrusions. More descriptions about the multi-arc ion plating may be found in the relevant description above.

In some embodiments, operations for preparing the nano-sized depressions are similar to operations for preparing micron-sized depressions, such as preparing a mixed slurry containing hard fine grains with a particle size of 0.2±0.1 μm, and performing subsequent pressing steps to prepare the nano-sized depressions. More descriptions of the pressing process may be the relevant description above.

In some embodiments, by further including the nano-sized concavities and convexities in the micro-nano concave-convex structure, the surfaces of the micron-sized concavities and convexities are superimposed with the nano-sized concavities and convexities, setting the diameter distribution of the micron-sized concavities and convexities to 0.2-100 μm, and setting the diameter distribution of the nano-sized concavities and convexities to 0.01-0.2 μm, a contact area between the inner surface of the non-stick pan and food is further reduced, while multi-scale oil-retaining spaces are formed, thus further improving the non-stick performance.

In some embodiments, the hard fine grains include at least one of boron carbide, silicon carbide, silicon nitride, boron nitride, or carborundum.

In some embodiments, by selecting the boron carbide, silicon carbide, silicon nitride, boron nitride, carborundum, etc., as the hard fine grains, the above raw materials are low-cost, diverse in type, stably supplied, and readily obtainable, thereby effectively ensuring the economy and continuity of production.

The mixed slurry refers to a paste prepared based on the hard fine grains. A formulation of the mixed slurry may be determined based on actual needs.

In some embodiments, the mixed slurry includes the hard fine grains, a dispersant, a binder, a stabilizer, a preservative, a solvent, etc. The solvent may include water or an oily solvent (e.g., glycerin, ethyl acetate, pine oil, etc.).

In some embodiments, the mixed slurry includes the hard fine grains, an amino carboxylic acid, polyethylene glycol, and water.

The amino carboxylic acid serves as a dispersant to prevent agglomeration of the hard fine grains in the mixed slurry, ensuring uniform dispersion of the hard fine grains in the mixed slurry.

In some embodiments, the amino carboxylic acid includes nitrilotriacetic acid, ethylenediaminetetraacetic acid, di(hydroxyethyl) glycine, oleylamine diacetic acid, or the like.

The polyethylene glycol serves as a binder to improve the viscosity and fluidity of the mixed slurry. When the polyethylene glycol is mixed with water, a viscous paste can be formed, which uniformly coats and disperses the hard fine grains, thereby preventing the hard fine grains from settling due to density differences.

A polymerization degree of the polyethylene glycol may be determined based on actual needs. In some embodiments, a binder such as polyvinyl alcohol can also be used.

In some embodiments, a binder such as polyethylene glycol is added to water, followed by adding the hard fine grains, a dispersant, and other components. After stirring and homogenization, a mixed slurry with stable properties may be obtained. The homogenization may include ultrasonic homogenization, shear homogenization, etc.

In some embodiments, a weight percentage of water in the mixed slurry is greater than 40%.

In some embodiments, the weight percentage of water in the mixed slurry may also be one of 45%, 50%, 55%, 60%, 65%, or 70%.

In some embodiments, the weight percentage of water in the mixed slurry may also be one of 40%-50%, 45%-60%, 50%-70%, 60%-70%, 40%-60%, 55%-65%, or 40%-65%.

In some embodiments, compared to directly pressing dry hard particles, the mixed slurry prepared based on the hard fine grains, the amino carboxylic acid, the polyethylene glycol, and water, has the advantages of generating less dust, being easier to recover after use, and allowing more convenient coating.

In some embodiments, the mixed slurry can be coated onto the surface of the metal plate by brushing, blade coating, roll coating, or the like. Parameters such as a coating thickness of the mixed slurry may be determined based on actual needs.

The metal plate refers to a base material for manufacturing the non-stick pan. In some embodiments, the metal plate may be a metal plate made of a single material. For example, the metal plate includes a stainless steel plate, a titanium plate, an iron plate, or the like.

In some embodiments, to enhance thermal conductivity and the application range of the non-stick pan, the metal plate may be a composite metal plate made of different materials. For example, the metal plate includes a multi-layer composite structure, which, from an inner surface to an outer surface, includes a two-layer composite plate of stainless steel and aluminum, or a three-layer composite plate of titanium, aluminum, and stainless steel. A material and a count of layers of the metal plate may be determined based on actual needs.

In some embodiments, the metal plate can also be made of austenitic titanium material or martensitic titanium material. Even during high-temperature stir-frying or when the pan is heated empty, the non-stick pan does not release any toxic substances or gases and does not contaminate the food being cooked or the kitchen environment, thus ensuring safer cooking.

The coated metal plate refers to a metal plate with a mixed slurry coating obtained after uniformly coating the mixed slurry onto the surface of the metal plate. For more details regarding the mixed slurry and coating, refer to the relevant descriptions above.

Operation 2, performing a roll pressing or a flat pressing on the coated metal plate to obtain a pressed metal plate.

In some embodiments, the roll pressing includes: controlling roll press wheels to perform a roll pressing on the coated metal plate to obtain the pressed metal plate; the flat pressing includes controlling a hydraulic press to perform a flat pressing on the coated metal plate to obtain the pressed metal plate.

The roll pressing refers to a process of continuously applying rolling pressure to the coated metal plate through the roll press wheels. The roll pressing utilizes the rolling pressure of the roll press wheels to cause the hard fine grains to imprint the surface of the metal plate, thus forming depressions. The roll pressing allows for continuous processing, suitable for batch processing of wide metal plates.

In some embodiments, a single wide roll press wheel may be used for the roll pressing.

In some embodiments, because a single wide roll press wheel is relatively costly, a plurality of narrow roll press wheels can be arranged and used for the roll pressing.

The pressed metal plate refers to a metal plate after pressing is completed. A surface of the pressed metal plate includes depressions and may be used to prepare the non-stick pan.

In some embodiments, the roll press wheels have a width of 10-30 cm, and the metal plate has a width of 1-2.4 m. The roll press wheels include a plurality of roll press wheels arranged in sequence, and an arrangement of the plurality of roll press wheels is an aligned arrangement or a staggered arrangement, and the total width of the plurality of the roll press wheels is not less than the width of the metal plate.

In some embodiments, the width of the roll press wheels may also be one of 10 cm, 15 cm, 20 cm, 25 cm, or 30 cm.

In some embodiments, the width of the roll press wheels may also be one of 10 to 15 cm, 15 to 20 cm, 20 to 25 cm, 25-30 cm, 10-20 cm, 15-25 cm, or 20-30 cm.

In some embodiments, the width of the metal plate may be one of 1 m, 1.2 m, 1.5 m, 1.8 m, 2 m, 2.2 m, or 2.4 m.

In some embodiments, the width of the metal plate may be one of 1-1.5 m, 1.5-2 m, 2-2.4 m, 1-1.2 m, 1.2-1.5 m, 1.5-1.8 m, 1.8-2 m, 2 -2.2 m, 2.2-2.4 m, 1-2 m, or 1.5-2.4 m.

In some embodiments, the arrangement of the plurality of roll press wheels may be determined based on actual needs.

In some embodiments, the arrangement of the plurality of roll press wheels is the aligned arrangement or the staggered arrangement.

The aligned arrangement refers to the plurality of roll press wheels being distributed in a single row, in which the wheels are aligned without any front-back offset, forming an overall linear arrangement. The staggered arrangement refers to the plurality of roll press wheels being distributed in two or more rows with misalignment, in which the gaps between the wheels in the front row are covered by the wheels in the rear row, forming an overall zigzag pattern.

In some embodiments, to prevent the surface of the metal plate from having areas that cannot be pressed and to improve utilization of the metal plate, the total width of the plurality of roll press wheels is not less than the width of the metal plate.

In some embodiments, setting the width of the roll press wheels to 10-30 cm and the width of the metal plate to 1-2.4 m; sequentially arranging the plurality of roll press wheels, where the arrangement is the aligned arrangement or the staggered arrangement, and the total width of the plurality of roll press wheels is not less than the width of the metal plate. The manufacturing, replacement, and maintenance costs of narrow roll press wheels are significantly lower than those of a single wide roll press wheel. By arranging a plurality of small roll press wheels to perform the roll pressing, equipment costs can be significantly reduced. Furthermore, when an individual roll press wheel wears out, only that wheel needs to be replaced without requiring replacement of the entire assembly, thereby lowering subsequent maintenance costs.

The flat pressing refers to a process of statically applying pressure to the coated metal plate via the hydraulic press. The flat pressing utilizes the vertical pressure of the hydraulic press to cause the hard fine grains to imprint the surface of the metal plate, thus forming depressions. The flat pressing is suitable for processing a shaped metal plate.

In some embodiments, the roll pressing or the flat pressing can be performed a plurality of times on the coated metal plate to obtain the pressed metal plate.

In some embodiments, different mixed slurries can be used during the repeated roll pressings or the repeated flat pressings. For example, during a first pressing, a mixed slurry includes hard fine grains with a particle size distribution of 50±20 μm and 5±2 μm, used to form micron-sized depressions. During a second pressing, a mixed slurry includes hard fine grains with a particle size distribution of 0.2±0.1 μm, used to form nano-sized depressions and ensure surfaces of the micron-sized depressions are superimposed with the nano-sized depressions.

In some embodiments, by performing the roll pressing or the flat pressing repeated a plurality of times, repeated pressings can achieve a more uniform stress distribution, avoiding deformation of the metal plate caused by excessive pressure in a single pressing.

In some embodiments, a pressing pressure applied by the hydraulic press is greater than 6000 tons. For example, the pressing pressure may be one of 6500 tons, 7000 tons, 7500 tons, 8000 tons, 8500 tons, 9000 tons, 9500 tons, or 10000 tons.

In some embodiments, by setting the pressing pressure of the hydraulic press to be greater than 6000 tons, a pressing effect of the flat pressing can be ensured, and depressions with uniform diameters may be obtained.

Operation 3, preparing a coating-free non-stick pan based on the pressed metal plate.

In some embodiments, the coating-free non-stick pan may be prepared based on the metal plate in a plurality of ways. For example, the metal plate is stamped into the shape of a pan body, and then steps such as leveling, trimming, and welding of a pan handle are performed, and finally, the non-stick pan is prepared.

In some embodiments, Operation 3 further includes:

Operation 31, removing and recycling the mixed slurry from a surface of the pressed metal plate to obtain a blank metal plate.

In some embodiments, after pressing is completed, tools such as a scraping strip and a scraper can be used to remove and recycle the mixed slurry from the surface of the pressed metal plate, thereby further reducing production costs.

Operation 32, cleaning a surface of the blank metal plate to prepare a standby metal plate.

In some embodiments, a cleaning agent may be used to clean the surface of the blank metal plate to remove residual mixed slurry, oil stains, and other dirt, thereby obtaining a clean standby metal plate.

Operation 33, stamping the standby metal plate with the hydraulic press to form the pan body of the coating-free non-stick pan.

In some embodiments, the standby metal plate is placed in a mold and stamped by the hydraulic press to obtain the pan body of the non-stick pan with a specific shape. By using molds of different sizes and shapes, non-stick pans of different styles can be produced.

Operation 34, welding components including the pan handle to the pan body to obtain the coating-free non-stick pan.

In some embodiments, a finished non-stick pan may be obtained through subsequent steps such as deburring and painting an outer surface of the non-stick pan.

In some embodiments, since the roughness of the metal surface affects the non-stick performance of the non-stick pan, surface modification may also be performed to improve the non-stick performance. The surface modification includes metal passivation modification, sandblasting treatment, etc., thereby changing the roughness of the inner surface of the non-stick pan. The surface modification further includes hardening treatment to enhance the wear resistance of the non-stick pan. After the surface modification, the non-stick pan reaches a Grade 1 of the Chinese National Standard GB/T 32095.2-2015 for cookware.

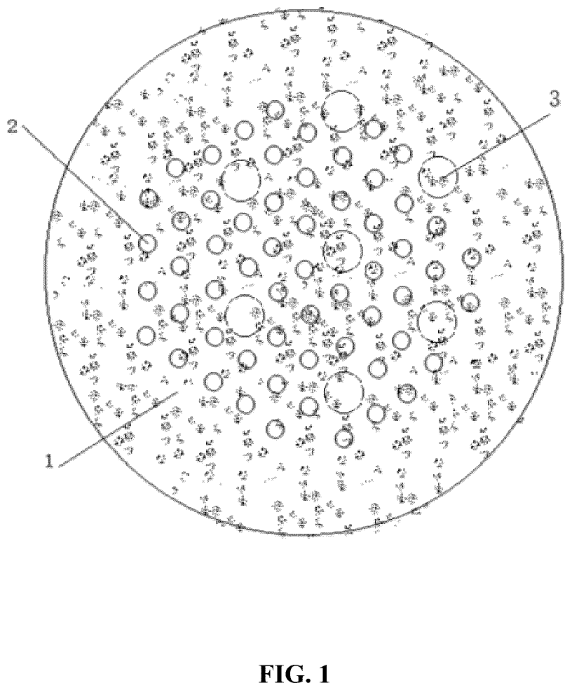

FIG. 1 is a schematic diagram illustrating a depressions distribution on an inner surface of a non-stick pan according to some embodiments of the present disclosure. As shown in FIG. 1, concave holes are distributed on the inner surface of the non-stick pan, such as a first-type concave hole 3 and a second-type concave hole 2, and a region between adjacent concave holes is a pan body plane 1. In FIG. 1, black dots denote nano-sized concavities and convexities (e.g., nano-sized depressions or nano-sized protrusions).

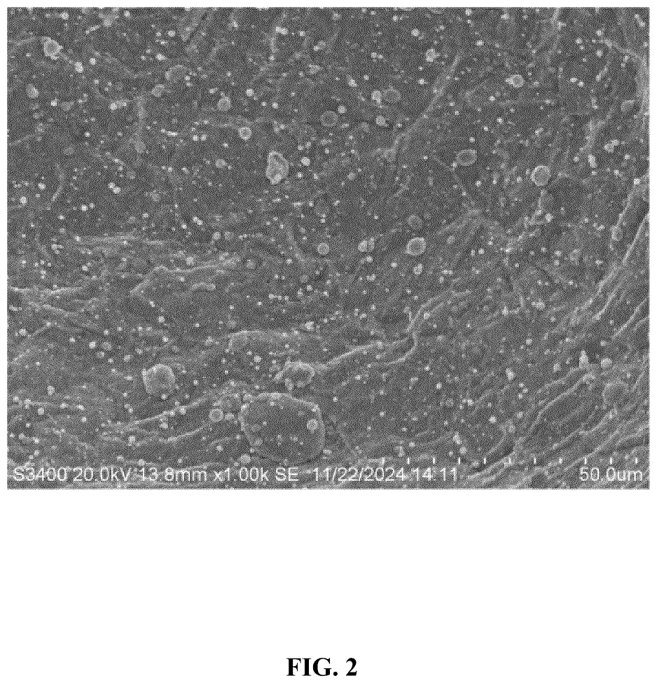

FIG. 2 is a schematic diagram illustrating an enlarged view of concave holes on an inner surface of a non-stick pan prepared according to some embodiments of the present disclosure. As shown in FIG. 2, surfaces of the concave holes on the inner surface of the non-stick pan are relatively smooth, yet there is a plurality of micro-nano concave-convex structures, indicating that the inner surface of the non-stick pan is relatively rough and exhibits good non-stick performance.

The non-stick pan prepared according to the present disclosure exhibits good surface hardness and toughness. The oil and liquid retained in the micro-nano concave-convex structure on the inner surface evaporate upon heating, lifting the food to be heated. The micron-sized concavities and convexities exhibit excellent non-stick performance, and the particulate films formed by ion plating exhibit strong adhesion to the inner surface of the non-stick pan. Furthermore, the micro-nano concave-convex structure enhances the slipperiness of the inner surface, reducing the friction between the food and the inner surface, thereby allowing flipping and stirring with a spatula of appropriate hardness to be easier. The non-stick performance is essentially comparable to the level of new PTFE (Teflon) coating, while manufacturing costs remain low. By uniformly spacing one or two types of concave holes (e.g., millimeter-sized concave holes or micron-sized concave holes) in a superimposed manner, the gas evaporated during food heating can more easily bulge out through the concave holes during general frying (with better effects when the pan or spatula is moved), thus enhancing the non-stick effect.

Although the embodiments of the present invention have been shown and described above, it should be understood that the above embodiments are exemplary and should not be construed as limitations of the present invention. Those of ordinary skill in the art can make changes, modifications, substitutions, and variations to the above embodiments within the scope of the present invention without departing from the principles and spirit of the present invention.

What is claimed is:

1. A coating-free non-stick pan, wherein
an inner surface of the coating-free non-stick pan is provided with a uniformly distributed micro-nano concave-convex structure, and the micro-nano concave-convex structure include micron-sized concavities and convexities;
the micron-sized concavities and convexities include micron-sized protrusions or micron-sized depressions;
the micron-sized protrusions are formed by particulate films formed by particles, the particulate films have a thickness of 0.1-0.98 μm, and the particles have a particle size of 0.02-0.3 μm; and
the micron-sized depressions have a diameter of 0.1-0.98 μm.

2. The coating-free non-stick pan of claim 1, wherein the micron-sized depressions are provided with multi-level diameter dimensions;
a diameter distribution of the micron-sized depressions further includes 40±20 μm or 5±2 μm;
the micron-sized depressions are fabricated using a pressing process or an etching process; and
the micron-sized depressions have a depth of 20-1500 nm.

3. The coating-free non-stick pan of claim 2, wherein a pore diameter distribution of the micron-sized depressions includes 40±20 μm, 5±2 μm, and 0.2±0.1 μm.

4. The coating-free non-stick pan of claim 1, wherein a material of the inner surface includes stainless steel, titanium, or iron.

5. The coating-free non-stick pan of claim 1, wherein the inner surface is further provided with uniformly distributed concave holes;
the concave holes have a pore diameter of 0.1-0.8 mm, an inter-edge distance of 0.1-2 mm, and a hole depth of 0.01-0.3 mm, a projection area of the concave holes constitutes 15-40% of a pan body area, and the concave holes are in a circular or polygonal shape; and
the concave holes have a continuously concave profile.

6. The coating-free non-stick pan of claim 5, wherein the concave holes have a pore diameter of 0.3-0.5 mm.

7. The coating-free non-stick pan of claim 5, wherein the concave holes include a first-type concave hole and a second-type concave hole;
the first-type concave hole has a pore diameter of 0.3-0.8 mm, an inter-edge distance of 0.6-8 mm, and a hole depth of 0.01-0.3 mm; and
the second-type concave hole has a pore diameter of 0.05-0.29 mm, an inter-edge distance of 0.1-0.9 mm, and a hole depth of 0.01-0.3 mm.

8. The coating-free non-stick pan of claim 1, wherein the inner surface is provided with non-uniformly distributed concave holes;
a density of the concave holes in a bottom region of the coating-free non-stick pan is greater than that a density of the concave holes in a peripheral region of the coating-free non-stick pan.

9. The coating-free non-stick pan of claim 4, wherein the material of the inner surface is stainless steel, titanium, or iron, a material of an outer surface or an intermediate layer of the coating-free non-stick pan includes aluminum.

10. A method for preparing the coating-free non-stick pan of claim 1, comprising:
preparing a mixed slurry by proportionally mixing hard fine grains and coating the mixed slurry onto a surface of a metal plate to obtain a coated metal plate;
performing a roll pressing or a flat pressing on the coated metal plate to obtain a pressed metal plate; and
preparing the coating-free non-stick pan based on the pressed metal plate.

11. The method of claim 10, wherein a particle size distribution of the hard fine grains includes at least two particle sizes of 50±20 μm, 5±2 μm, and 0.2±0.1 μm.

12. The method of claim 10, wherein the hard fine grains include at least one of boron carbide, silicon carbide, silicon nitride, boron nitride, or carborundum.

13. The method of claim 11, wherein the hard fine grains have a particle size of 0.2±0.1 μm, and the particle size distribution of the hard fine grains includes at least two particle sizes of 50±20 μm and 5±2 μm.

14. The method of claim 10, wherein the method further includes:
performing the roll pressing based on roll press wheels, wherein the roll press wheels have a width of 10-30 cm, and the metal plate has a width of 1-2.4 m;
wherein the roll press wheels include a plurality of wheels arranged in sequence, wherein an arrangement is an aligned arrangement or a staggered arrangement, and a total width of the plurality of the roll press wheels is not less than a width of the metal plate.

15. The method of claim 10, wherein the micro-nano concave-convex structure further includes nano-sized concavities and convexities, surfaces of the micron-sized concavities and convexities are superimposed with the nano-sized concavities and convexities; the micron-sized concavities and convexities have a diameter distribution of 0.2-100 μm, and the nano-sized concavities and convexities have a diameter distribution of 0.01-0.2 μm.

16. The method of claim 10, wherein the mixed slurry includes the hard fine grains, an amino carboxylic acid, polyethylene glycol, and water.

17. The method of claim 10, wherein the coated metal plate performs the roll pressing or flat pressing repeated a plurality of times to obtain the pressed metal plate.

18. The method of claim 10, wherein performing the flat pressing, a hydraulic press is configured to apply a pressing pressure greater than 6000 tons.

19. The method of claim 10, wherein the preparing the coating-free non-stick pan based on the pressed metal plate includes:
removing and recycling the mixed slurry from a surface of the pressed metal plate to obtain a blank metal plate;
cleaning a surface of the blank metal plate to prepare a standby metal plate;
stamping the standby metal plate with a hydraulic press to form a pan body of the coating-free non-stick pan; and
welding components including a pan handle to the pan body to obtain the coating-free non-stick pan.
